(19) United States
(12) Patent Application Publication
(10) Pub. No.: US 2019/0310760 A1
(43) Pub. Date: Oct. 10, 2019

(54) METHOD AND APPARATUS FOR SPATIO-DATA COORDINATION

(71) Applicant: Monash University, Clayton (AU)

(72) Inventors: Maxime CORDEIL, Clayton (AU); Tim DWYER, Clayton (AU); Yongchao LI, Clayton (AU); Benjamin BACH, Clayton (AU); Elliott WILSON, Clayton (AU); Jon MCCORMACK, Clayton (AU)

(21) Appl. No.: 16/379,562

(22) Filed: Apr. 9, 2019

(30) Foreign Application Priority Data
Apr. 10, 2018 (AU) 2018202521

(51) Int. Cl. G06F 3/0481; G06T 19/00; G06F 3/0484; G06F 3/01

(52) U.S. Cl. CPC G06F 3/04815; G06T 19/00; G06T 2219/012; G06F 3/011; G06F 3/04847

(57) ABSTRACT

The invention is directed to “spatio-data coordination” (SD coordination) which defines the mapping of user actions in physical space into the space of data in a visualisation. SD coordination is intended to lower the user's cognitive load when exploring complex multi-dimensional data such as biomedical data, multiple data attributes vs time in a space-time-cube visualisation, or three-dimensional projections of three-or-higher-dimensional data sets.

### CROSS REFERENCE TO RELATED APPLICATIONS

The present application claims priority to Australian Application No. 2018202521 entitled A METHOD AND APPARATUS FOR SPATIO-DATA COORDINATION,” filed Apr. 10, 2018. The entire contents of the above-listed application are hereby incorporated by reference for all purposes.

### FIELD OF INVENTION

The present invention relates to the field of coordinating virtual and physical environments, including those where the interaction is visual within a physical space.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Numerous applications require three-dimensional spatial understanding and reasoning. The inventors have realised that in Scientific Visualisation applications where the data has intrinsic geometry—such as tumour or particle flow visualisation—the importance of true three-dimensional spatial representation is useful. However, in the field of Information Visualisation where abstract data (abstract meaning without an intrinsic geometry) is also commonly considered, studies have demonstrated that spatial position is an effective channel for mapping a quantitative data attribute to a visual representation. The inventors have realised that two different data attributes mapped to two spatial dimensions have been used to visualise in, for example, scatterplots, space-time-cubes, and multi-dimensional scaling. It is desirable to extend such a mapping to three different data attributes in three spatial dimensions, but 2D screens are considered problematic in accurately representing and interacting with 3D objects and spaces.

Virtual, Mixed and Augmented Reality displays (V/AR) have recently reached a new level of maturity as consumer products with high-resolution displays and precise, low-latency head-motion tracking are available. These factors, together with the benefits of stereovision and kinaesthetic depth, the inventors have realised greatly improve human perception of 3D space and could fuel a new consideration of 3D data visualisations.

Two-dimensional interaction devices (e.g. mice, touch-screens and pen input) have the appealing property that they offer precise control through movements constrained to a plane, and hence mapping directly to the display space, and in the case of a 2D data visual, directly to the 2D data space. There is a need to bring this interaction to 3D data and immersive environments.

The inventors have realised that most tasks in visualisation require some sort of selection and navigation mechanism. In 3D visualisations, this includes selecting values and ranges along each dimension, selecting specific elements in each combination of dimensions, defining cutting planes, selecting points and shapes in space, or magnifying the space through lenses. For 3D visualizations of abstract spatio-temporal data, the operations involve the definition of cutting planes, “drill-cores” and arbitrary 3D shapes. Some of these operations can be extended to general 3D visualisation.

Currently, there is a range of modalities available to perform interactions in 3D spaces, such as: mouse-based; surface+touch-based; midair-based; and tangible user interfaces.

Mouse and Surface+Touch Interfaces

In L. Yu, K. Efstathiou, P. Isenberg, and T. Isenberg; Cost Effective and efficient user interaction for context-aware selection in 3d particle clouds, IEEE transactions on visualization and computer graphics, 22 (1):886-895, 2016, there is disclosed a computer-aided way to select 3D point clouds on touch screens, based on point density within the user-drawn lasso.

In D. Lopez, L. Oehlberg, C. Doger, and T. Isenberg; Towards An Understanding of Mobile Touch Navigation in a Stereoscopic Viewing Environment for 3d Data Exploration, IEEE Transactions on Visualization and Computer Graphics, 22 (5):1616-1629, May 2016, there is disclosed a tablet-based navigation on stereoscopic display for scientific 3D visualisation such as structural biology. They present the t-box technique, a cubic widget designed to manipulate the visualisation (rotation by dragging the cube's faces, translation by dragging the cube's edges and scaling by pinching the cube). They also made use of the tablet's gyroscope to enable rotation of the 3D model from the tablet orientation.

Mid-Air Interfaces

The inventors realise that there has been little research on mid-air interaction in the context of data visualisation.

In B. Laha and D. A. Bowman; Design of the bare-hand volume cracker for analysis of raw volumetric data, Front. Robot. AI, 3:56, September 2016, there is a disclosure of a volume cracker, a technique that uses a Leap Motion (a commercial vision-based hand-tracker) and allows—via mid-air interaction—the direct manipulation and separation of volumes in scientific visualisations.

In B. P. Miranda, N. J. S. Carneiro, T. D. O. de Araújo, C. G. R. dos Santos, A. A. de Freitas, J. Magalhães, and B. S. Meiguins; Categorizing issues in mid-air infovis interaction, Information Visualisation (IV), 2016 20th Inter-national Conference, pages 242-246, IEEE, 2016, there is a disclosure of the use of gestures to support 3D scatterplot InfoVis tasks. They found three main categories of issues using mid-air gestures: the size of the tracking volume; ambiguity of the gestures and ambiguities in depth perception while using a 2D screen.

In R. Theart, B. Loos, and T. Niesler; Virtual Reality Assisted Microscopy Data Visualization and Colocalization Analysis, Proc. of BioVis Workshop at IEEE VIS, 2016, there is disclosed a 3D scatterplot and coordinated views in virtual reality, using a head-mounted display and a Leap Motion controller.

The inventors realise that using mid-air interactions a user can scale and rotate the visualisation as well as select data points by defining volumes inside the visualisation.

Tangible User Interfaces

Tangible user interfaces (TUIs) use physical artifacts for interaction—see for example G. W. Fitzmaurice, H. Ishii, and W. A. Buxton; Bricks: laying the foundations for graspable user interfaces, Proceedings of the SIGCHI conference on Human factors in computing systems, pages 442-449, ACM Press/Addison-Wesley Publishing Co., 1995. Y. Jansen, P. Dragicevic, and J.-D. Fekete; Evaluating the efficiency of physical visualizations, Proceedings of the SIGCHI Conference on Human Factors in Computing Systems, pages 2593-2602, ACM, 2013 and F. Taher, J. Hardy, A. Karnik, C. Weichel, Y. Jansen, K. Hornbæk, and J. Alexander; Exploring interactions with physically dynamic bar charts, Proceedings of the 33rd Annual ACM Conference on Human Factors in Computing Systems, pages 3237-3246, ACM, 2015, have disclosed that positive user feedback from directly touching physical models and the immersiveness of a virtual environment can benefit from any sort of tangible interface.

TUIs for 3D visualisations have been designed to support navigation, selection, and menu interaction, as summarised in J. Jankowski and M. Hachet; A survey of interaction techniques for interactive 3d environments, Eurographics 2013-STAR, 2013.

Some TUIs conceptually extend the mouse in that they allow for basic navigational input, e.g. camera rotation or menu selection. U.S. Pat. No. 5,729,249 discloses a cube input device with touch-sensitive faces and edges. This device does not track absolute orientation in the user's hands. Rotations are performed with drag interactions on opposite faces. Similarly, the disclosure in A. Roudaut, D. Martinez, A. Chohan, V.-S. Otrocol, R. Cobbe-Warburton, M. Steele, and I.-M. Patrichi; Rubikon: a highly reconfig-urable device for advanced interaction, Proceedings of the extended abstracts of the 32nd annual ACM conference on Human factors in computing systems, pages 1327-1332, ACM, 2014; implements interactions on a rotatable Rubix cube, including discrete rotation in 3D environments. Other cube-shaped devices have been used for navigation menus and setting state variables, such as in J. Rekimoto and E. Sciammarella; Toolstone: effective use of the physical manipulation vocabularies of input devices, Proceedings of the 13th annual ACM symposium on User interface software and technology, pages 109-117, ACM, 2000. However, these devices do not support selection tasks, nor are they specifically designed for data visualisations.

A third class of devices emulates the virtual space in the user's physical space by mapping dimensions, positions and actions between both spaces. An early example of such a tangible user interface for navigating 3D visualisations was presented in K. Hinckley, R. Pausch, J. C. Goble, and N. F. Kassell; Passive real-world interface props for neurosurgical visualization, Proceedings of the SIGCHI conference on Human factors in computing systems, pages 452-458. ACM, 1994. It consisted of a physical rubber band to define a cutting plane in the visualisation. Another such device is the Cubic Mouse disclosed in B. Fröhlich and J. Plate; The cubic mouse: a new device for three-dimensional input, Proceedings of the SIGCHI conference on Human Factors in Computing Systems, pages 526-531, ACM, 2000; and allowed for selection inside a 3D volume through movable rods and buttons mounted to the device. K. J. Kruszyński and R. van Liere; Tangible props for scientific visualization: concept, requirements, application, Virtual Reality, 13 (4):235-244, 2009, disclosed a 3D printed a coral model and attached sensors to enable pointing on the model. The orientation of the 3D printed model was tracked and synchronised with a higher resolution visualisation of the model displayed on a 3D stereo monitor. In M. Spindler and R. Dachselt; Paperlens: advanced magic lens inter-action above the tabletop, Proceedings of the ACM International Conference on Interactive Tabletops and Surfaces, page 7, ACM, 2009, there is disclosed a hand-held cutting plane, movable in 3D space, onto which virtual imagery is projected. Further, in A. Chakraborty, R. Gross, S. McIntee, K. W. Hong, J. Y. Lee, and St Amant; Captive: a cube with augmented physical tools, In CHI'14 Extended Abstracts on Human Factors in Computing Systems, pages 1315-1320. ACM, 2014, is disclosed an AR system consisting of a cube wireframe and a pointing device. While the wireframe is used to track rotation and absolute position of the visualisation, the pointing device is used to point to positions inside the wireframe.

### SUMMARY OF INVENTION

It is an object of the embodiments described herein to overcome or alleviate at least one of the above noted drawbacks of related art systems or to at least provide a useful alternative to related art systems.

In one form, the invention relates to a mapping of positions, directions, and/or actions from a physical environment of a user to the virtual space of data, and vice-versa.

In one particular aspect the present invention is suitable for use as virtual, augmented and mixed reality environments and with displays including interactive displays and/or display methods based, at least in part, on those environments in any combination or any selection thereof.

It will be convenient to hereinafter describe the invention in relation to the mapping of user actions in physical space into the space of data in a visualisation, and vice-versa, however it should be appreciated that the present invention is not limited to that use only.

In a first aspect of embodiments described herein there is provided a 2D display adapted to show a virtual object in a defined area, comprising a first dimension and a second dimension defining a 2D display area, each dimension interfacing with a corresponding portion of the 2D display, each dimension selectively defining an area to be displayed corresponding to that dimension, the display providing a visual representation of the object, the display providing a mutual interaction between the area and the visual representation in the first and second dimensions.

Preferably, the display further comprises a third dimension enabling a 3D display area, each dimension interfacing with a corresponding portion of the 3D display area.

In another aspect of embodiments described herein there is provided a method of displaying a virtual object in 2D, namely in a first and second dimension, the method comprising the steps of providing a 2D display area, bounded by the first and second dimensions, displaying at least a portion of an object visually within the 2D display area, and selectively controlling the portion of the object displayed by defining, in each dimension, a display range, the display range corresponding to the portion of the object being displayed in the 2D display area.

Preferably, the method further comprises the step of providing a third dimension, and to providing a 3D display area, bounded by the first, second and third dimensions, displaying at least a portion of an object visually within the 3D display area, and selectively controlling the portion of the object displayed by defining, in each dimension, a display range, the display range corresponding to the portion of the object being displayed in the 3D display area.

In yet a further aspect of embodiments described herein there is provided a method of displaying a virtual object in 2D, namely in a first and second dimensions, the method comprising providing a physical 2D display area, bounded by the first and second dimensions, displaying at least a portion of an object visually within the 2D display area the method further comprising, in a first mode, selectively controlling the portion of the object displayed by defining, in each dimension, a display range, the display range corresponding to the portion of the object being displayed in the 2D display area wherein the selective control is provided by a user defining the display range in each dimension and optionally the orientation of the object in the display area, the method further comprising, in a second mode, selectively controlling the portion of the object displayed by defining, in each dimension, a display range, the display range corresponding to the portion of the object being displayed in the 2D display area wherein the selective control is provided by a user interacting with the virtual display to control the physical 2D display area bounded by the first, second and third dimensions.

Preferably, the method further comprises providing a third dimension, and providing a physical 3D display area, bounded by the first, second and third dimensions displaying at least a portion of an object visually within the 3D display area, the method further comprising, in a first mode, selectively controlling the portion of the object displayed by defining, in each dimension, a display range, the display range corresponding to the portion of the object being displayed in the 3D display area wherein the selective control is provided by a user defining the display range in each dimension and optionally the orientation of the object in the display area, the method further comprising, in a second mode, selectively controlling the portion of the object displayed by defining, in each dimension, a display range, the display range corresponding to the portion of the object being displayed in the 3D display area wherein the selective control is provided by a user interacting with the virtual display to control the physical 3D display area bounded by the first, second and third dimensions.

Other aspects and preferred forms are disclosed in the specification and/or defined in the appended claims, forming a part of the description of the invention.

In essence, embodiments of the present invention stem from the realization that there is a need to utilise immersive environments, such as virtual, augmented and mixed reality environments, for the mutual mapping in two or three dimensions of data visualisation and a physical space. This enables the understanding of 2D or 3D abstract and/or 3D spatial (such as scientific and engineering) data visualisation by interacting with the visualization as if it were in the real environment. The present invention, in one aspect, uses “Spatio-Data (SD) Coordination”, which means a one-to-one mapping of positions, directions, and actions from the physical environment of the user to the virtual space of the data and vice versa, so there is a mutual interaction between space and visual representation. Furthermore, the mutual mapping utilised by embodiments of the present invention enables actuating physical controls based on virtual/mid-air selections.

Advantages provided by the present invention comprise the following:

More precise/faster selections on decoupled axes;

Integration of multiple inputs for selections: mid-air, 2D surface, 1D guided along an axis;

Reduced cognitive load to perform interactive selections in 1, 2 and/or 3D;

Consistent mapping between virtual and physical cursors thanks to precise motor actuation;

Easy/faster re-acquisition of the physical cursors positions;

Mutual replication of actions and/or control with a display in both the virtual environment and physical environment;

integration of multiple input sensors to offer multiple modes to select 1, 2 and/or 3D values/range/volumes/surfaces of values;

relative ease of selection;

relative precision of selection;

relatively consistent mapping between virtual and physical cursors thanks to precise motor actuation and precise hand tracking;

relatively easy and faster re-acquisition of physical cursors to adjust/fine tune selections; and

mutual replication of actions and/or control with a display in both the visual an physical environment.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein.

The patent or application file contains at least one drawing executed in color. Copies of this patent or patent application publication with color drawing(s) will be provided by the Office upon request and payment of the necessary fee.

FIG. 1 illustrates SD coordination between physical interaction space and virtual visualisation space.

FIG. 2 illustrates a three-dimensional display device according to one embodiment.

FIG. 3 illustrates physical to virtual mapping.

FIG. 4 illustrates virtual to physical mapping according to one embodiment.

FIG. 5 illustrates coupling physical and virtual environments according to one embodiment.

FIG. 6 illustrates two-dimensional display devices according to one embodiment.

FIG. 7 illustrates a touch sensitive cube according to one embodiment.

FIG. 8 illustrates a virtual mid-air embodiment.

### DETAILED DESCRIPTION

For purposes of description herein, the terms “upper,” “lower,” “right,” “left,” “rear,” “front,” “vertical,” “horizontal,” “interior,” “exterior,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

In this specification, we coin the term Spatio-Data (SD) coordination, referring to interactions from a physical interaction-space into a digital visualisation-space, and visa-versa. FIG. 1 illustrates an example of this. “Data space” contains the data preferably in some sort of structured form, such as lists, tables, or graph structures; “Visualisation space” describes the visualisation or abstract visual form i.e. the visual mapping from data to visual attributes. In the context of three-dimensional data visualizations, this visual mapping includes the assignment of three-dimensional positions and shapes to data objects (e.g. 3D graph layout, point positions in a scatterplot, traces in a space-time cube, etc.); “Display space” refers to making the visualisation and corresponding state changes visible to the user, the visualisation space must be rendered into the physical environment of the user, creating a physical presentation. This rendering can happen on two-dimensional computer screens, stereo-screens, CAVE systems, hologram, or head-mounted virtual, mixed and/or augmented reality displays or any suitable display environment and/or device. “Interaction space” is a bounded part of the user's physical environment, such as a part of the user desktop or office; a space defined or nominated by the user, and preferably at least partially within the user's reach. The interaction space may be hand-size, desktop-size, human-size, finger-size and world-size and “Interaction” is any purposeful action performed by a user physically and/or virtually in the interaction space and which aims to change the state of the visualisation, creating, for example, a selection or a navigation action as will be described in more detail hereinafter.

Referring to FIG. 1, there is represented a Spatio-Data coordination between physical interaction space, and virtual visualisation space. A high-dimensional data space is (1) mapped into a (lower) three-dimensional visualisation space, which in turn is (2) rendered onto a display space, (3) perceivable by the user. Attributes become dimensions, data elements points in this space. Interaction happens in the interaction space and is (4) mapped to the visualisation space. Every interaction is mutually replicated in the virtual and physical environments and, preferably to aid the user, is made visible in the display space. In the interaction space, a device like a slider can be aligned to a data axis for range selection on that axis, or a touch surface can be aligned with two data axes such that two touch points create a selection across two data axes.

For example, for a visualization of a multi-dimensional scaling in three dimensions, the data-space may contain hundreds of dimensions associated with the individual data points. Through multi-dimensional scaling, the number of dimensions associated to each data point gets reduced to three. These three dimensions are then mapped to three orthogonal spatial dimensions in the visualisation space, for example axis x, y and z. Eventually, this three-dimensional Euclidean space is rendered, e.g. into a VR environment using an HMD.

In order to allow for spatio-interaction, we assume the interaction space has the following three characteristics:

1. It has to be of Euclidean nature and occupy a well-defined, bounded part of the user's physical environment;

2. The mapping between interaction and visualisation space has to be orientation-congruent, i.e. it has to preserve the space's orientation. For example, any position or movement towards the right of the user in the interaction space results in a movement to the right of the user in the visualisation space. The same holds true for all spatial dimensions (up-down/top-bottom, right-left, and towards-away from the user); and

3. We assume a “computer-in-the-loop”, i.e. a computer that processes input and generates an output in the form of a visualisation.

SD coordinated interaction devices are any devices and systems that use such a direct mapping between interaction and visualisation space and that satisfy the three conditions above. We believe that designing interaction systems for SD coordination decreases a user's cognitive load when exploring the data. Ideally, display and interaction would hence be “the same” in the user's physical environment, i.e. the user interacts with the visualisation where the visualisation is perceptually situated.

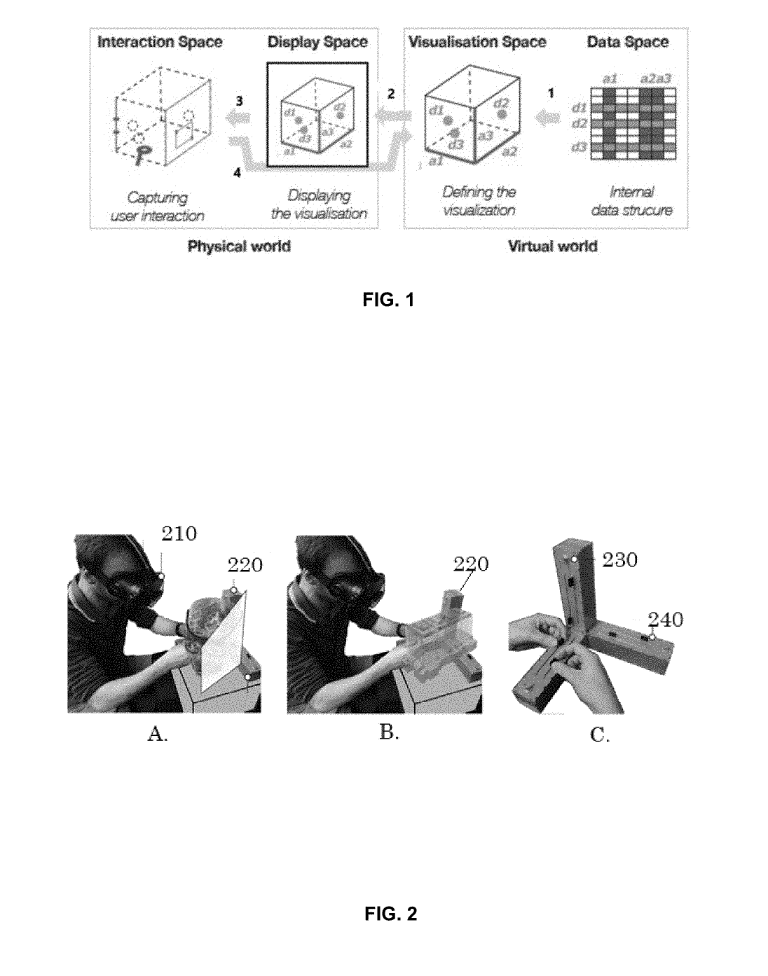

FIG. 2 illustrates a three-dimensional display device according to one embodiment of the present invention. FIG. 2(C) illustrates dimensions, such as an axis with slide controls. This is referred to as Fader Axis 250. A Fader Axis is a tangible input device that aids selection for 2D and 3D graphical objects. It is designed to make 1, 2 and 3-dimensional selections and range selections in 2D (computer screens, touch screens) and 3D (virtual reality) displays in conjunction with other one or all three dimensions such as axes. An example of a 2D Fader Axis with x axis 640 and y axis 650 is shown in further detail in FIG. 6. The faders act like selection parameters (minimum and maximum range values) onto 3 orthogonal axes mapping the X, Y, Z Euclidian space or mapping arbitrary data dimensions. The faders may be motorised.

The Fader Axes uses the original concept of physical and virtual selection coupling: there is a 1 to 1 mapping or mutual interaction between the selections parameters in the virtual model and the selection parameters on the slider, being in the physical environment. This has three implications:

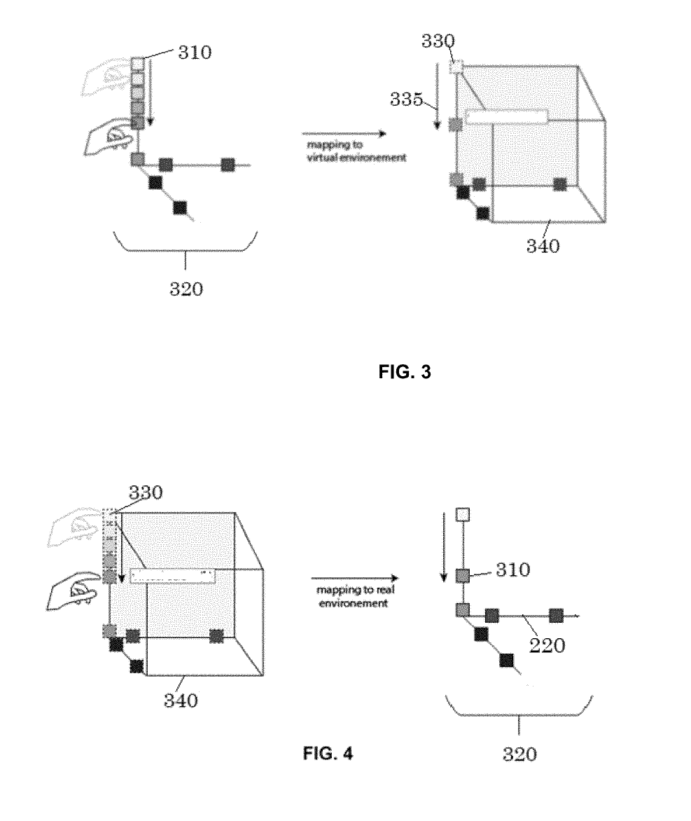

Physical to virtual mapping. Referring to FIG. 3, when a physical cursor 310 is moved along the physical axis 220 in the physical environment 320, the virtual cursor 330 moves in the virtual reality environment 340. In FIG. 3, the physical cursor 310 is moved for example with a hand along the Y axis, and the same cursor moves accordingly on the virtual display.

Virtual to physical mapping. Referring to FIG. 4, when a virtual cursor 330 is moved along the virtual axis 335, the physical cursor 310 is according to the present invention actuated and moves mutually to the corresponding value/position on the physical axes 220.

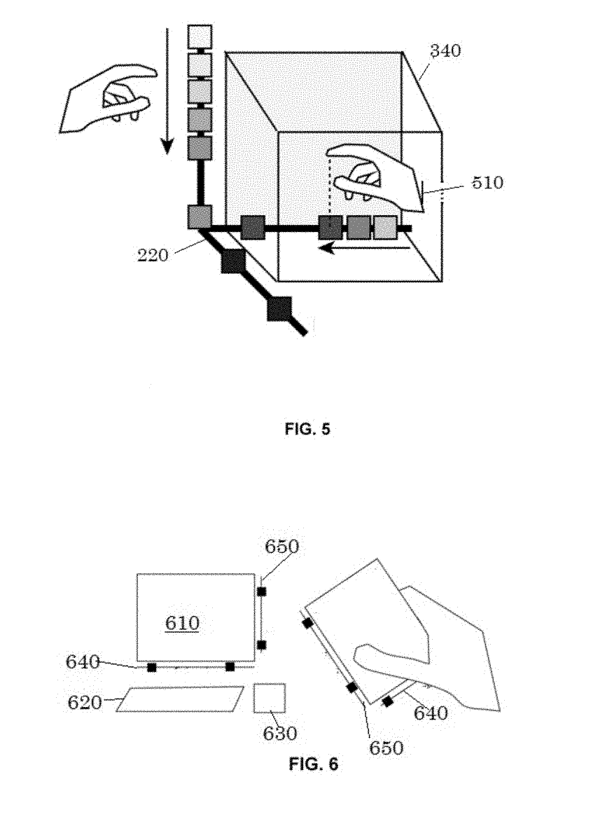

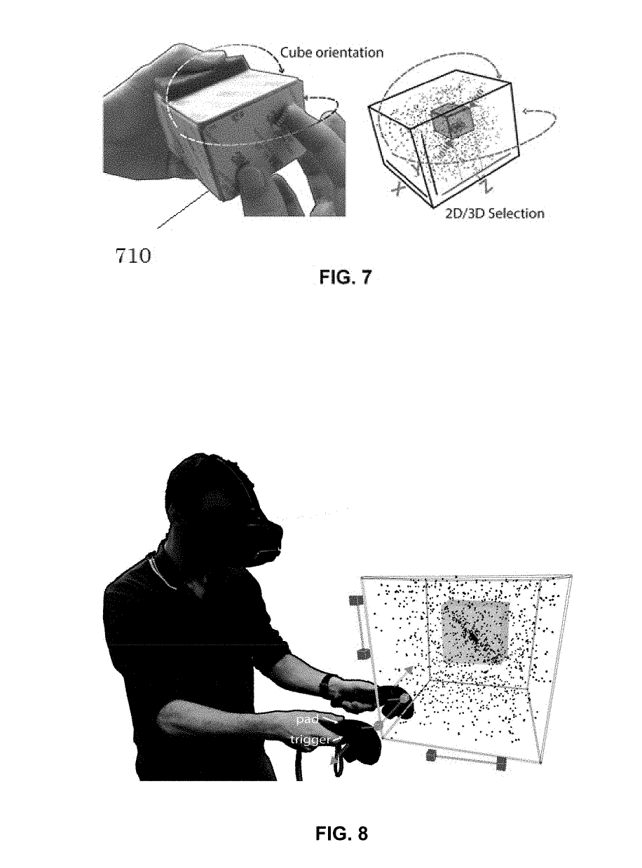

Coupling physical/virtual actions. Referring to FIG. 5, the hand 510 of the position of the hand of the user is tracked, for example in one embodiment, using a hand tracking system such as the Leap Motion or the Microsoft Kinect.

Possible physical design and implementations and interactions of the fader axes implementation include the following:

The number of physical and virtual sliders per axis:

one physical and motorized slider per axis and N virtual sliders—the physical axes is only equipped with one physical motorised slider, and range selection on this axis is performed by a coupled physical/interaction action with N additional virtual sliders. The virtual slider may be one or more icon on a screen.

N physical sliders and N virtual sliders (N>=1)—The physical axes is equipped with N (more than one) physical motorised slider, and range selection on this axis is performed by a coupled physical/interaction action with N additional virtual sliders.

The number of physical axes: possible implementations of physical and virtual interactions for value and range selection can involve:

one single axis (for one-dimensional selections only);

two orthogonal axes (for 1, 2 dimensional selections);

three orthogonal axes (for 1, 2, 3 dimensional selection); and

N axes, for N-dimensional selections (out of 3D Euclidian space, e.g. 1 axis for time).

The dimensions of the display and selections:

Two-dimensional display—e.g. 2D computer screen 610, touch screen, phone 660—examples are illustrated in FIG. 6. The two-dimensional display may additionally be connected to peripheral devices such as a keyboard 620 and/or mouse 630.

3D immersive display 210—e.g. Virtual Reality head mounted display or Augmented Reality head mounted display—see FIG. 2(A) and FIG. 2(B).

FIG. 2 illustrates an example of a 3D apparatus useful in implementing the present invention. The implementation of the Fader Axes uses a 3D immersive display such as the Microsoft Hololens, the Meta 2, the HTC Vive or the Oculus Rift.

The embodiment may use the Unity 3D (https://unity3d.com/) game engine to display the 3D immersive visualisations. 3D game engines facilitate the software creation/implementation of high quality 3D interactive visualisations with head mounted displays such as head mounted display 210. Unity and other game engines also facilitate the integration of the tracking technology used to track fingers and hand positions in a 3D space. Other libraries/toolkits can be used to produce similar 3D immersive visualisations.

The 3D Fader Axes (FIG. 2(c)) includes:

3 physical axes 220 that represents a 3D orthonormal referential (X, Y, Z);

2 actuated faders 240 are attached to each axis to select a range of values (a minimum and a maximum value); and

(optionally) 1 Rotary push button 230 is attached to each axis to rotate a model, and, e.g. validate a selection operation.

Embodiments of the present invention utilise a number of further features, one of which is that the faders or sliders are programmable. The sliders or faders are programmable in as much as the position of the cursor that indicates the value in the range can slide automatically thanks to a controlled motor. Specifically, the motor is controlled for example by a micro controller (here an Arduino board). Accordingly, the cursor on the controlled faders can jump rapidly to a specific position (for example, jump rapidly from value 0.1 to 0.75) and/or slide continuously along the axis (for example, while continuously matching the projected position on the axis of a tracked finger in 3D space).

In addition, or alternatively, a range slider may be used with only one physical sliding cursor, as long as one cursor position can be virtually set with a hand tracker. In this way, only 1 slider is need and a ‘border’ position can also be defined on the physical axis 220.

In embodiments of the present invention, the sliders give fine motor controls. Physical motorised potentiometer sliders can yield high precision. The motors can give very precise controls over the cursor position on the axis and therefore match precise user selections.

In spatio-data coordination embodiment, a pointer is, for example:

Virtual: Moved in 3D space with a hand-tracking device (such as the leapmotion, a 6DOF controller, kinnect . . . ).

Touch: Moved in 2D space for example on a touch screen.

Touch: Moved on a touch sensitive surface (e.g. on the faces of a cube 710).

Physical: Moved along sliding axis (e.g. on the fader cursors).

There may also be provided a pointer in the virtual environment that mutually operates the physical axis controls. A hand tracking device (e.g. a leap motion as manufactured by Leap Motion, Inc. San Francisco, Calif., USA) may be used to attach a virtual pointer on the tip of a finger. That is, like a mouse pointer on a screen can be moved with a hand movement by operating a mouse, a virtual pointer can be placed in a 2D or 3D space with a hand tracking device. This pointer has 2 or 3 coordinates (x, y, and/or z respectively) in the eucledian space and the orthonormal space: X, Y and/or Z. A virtual pointer (or several virtual pointers attached to several fingers on both hands) may be used to select values on the X, Y and/or Z axis. The physical sliders may use those (x, y and/or z) coordinate values to match the selection on the physical axis. Hence, a consequence is that a user can perform a rough selection using a virtual pointer in the virtual environment and then use the physical sliders that are now matching the selected values, to perform a more precise selection.

Preferably, the 3D space is “Euclidean.” A Eucledian orthonormal space is necessary to achieve proper 2D and 3D data visualisation. It ensures that distances between data points are comparable.

Preferably, that the interaction is orientation-congruent. This is important because in the spatio-data coordination concept, a user action (e.g. a selection) should be aligned with/should respect the rotation of the model, to make actions predictable and easy to operate.

The present invention may be put to various possible uses, such as:

3D CT scan analysis, e.g. to guide the exploration and the selection of potential tumours (FIG. 2A);

3D Building modelling, e.g. to help the navigation of 3D CAD models (FIG. 2, B); and

3D engineering simulation, e.g. to enhance the selection of 3D disconnected components.

In embodiments of the present invention, for example, a three-dimensional scatterplot visualisation may be a cube-shaped visualisation space, which can be decomposed into three visualisation components: edges, cube faces, and interior volume with data points.

Touch-sensitive Cube 710: a hand-sized tangible cube with rigid faces and edges (FIG. 2(A)). Touch sensitive faces and edges allow for selecting values on either, in a constrained and eyes-free manner. Interactions with one cube face allows 2D gestures to define a selection volume that passes through the entire data volume: e.g., a “pinch” gesture would create a selection volume with rectangular cross-section. Alternatively, the user might “draw” an arbitrary cross-section for the volume. Multiple 2D face selection can define a selection volume bounded in all three spatial dimensions. The cube is equipped with a gyroscope and accelerometer, tracking movement and rotation to enable navigation of the visualisation, e.g. moving it relative to the user's viewpoint. Thus, the affordances of this design allow users to rotate and manipulate the visualisation space in their hands in an ecologically correct way. Proprioception enables users to quickly navigate and access the faces and edges, without necessarily needing to look at the cube model in their hands.

Physical Axes 220—see FIG. 2—maps data axes to three physical range selection controls mounted orthogonally to one another. Thus, the Physical Axes 220 is a physical representation of the three axes of the Euclidian data space that allows interaction with the axes themselves but also enables users to reach inside the cube volume with their hand. A hologram of the visualisation is rendered within the Physical Axes 220 using a virtual reality head-mounted display (e.g. HTC Vive) or a mixed reality head-mounted display (e.g. Microsoft Hololens). This creates a direct mapping of the interaction in the display space. To support reaching inside the cube and potentially selecting and pointing to data objects, the device is desktop size. A user's hand position is tracked through a Leap motion controller and clicks as well as menu interaction are triggered through buttons attached to the axes. As axes are solid physical objects, they carry physical sliding knobs (FIG. 2(B)) allowing for precise value and range selection in each dimension, and also allow for volume selection.

Virtual Mid-air: Operated by unconstrained mid-air gestures (FIG. 8) with visualisation displayed in complete virtual reality (HTC Vive). Without any physical model of the data space, the interaction space can be human-sized, allowing for interaction with data that requires higher spatial resolution or authentic scales such as a human body.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system. For example, in some aspects, a computer program stored in non-transitory computer readable storage medium, when executed by a processor of a computer, causes the computer to execute the steps of displaying a virtual object in 2D, namely in a first and second dimension, and providing a 2D display area, bounded by the first and second dimensions displaying at least a portion of an object visually within the 2D display area selectively controlling the portion of the object displayed by defining, in each dimension, a display range, the display range corresponding to the portion of the object being displayed in the 2D display area. In further aspects, the computer program may execute the step of providing a third dimension, and to providing a 3D display area, bounded by the first, second and third dimensions, displaying at least a portion of an object visually within the 3D display area, and selectively controlling the portion of the object displayed by defining, in each dimension, a display range, the display range corresponding to the portion of the object being displayed in the 3D display area. In some aspects, the computer program stored in non-transitory computer readable storage media may be in the form of an application.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A display adapted to show a virtual object in a defined area, comprising:
a first dimension and a second dimension defining a 2D display area, each dimension interfacing with a corresponding portion of the 2D display, each dimension selectively defining an area to be displayed corresponding to the respective dimension, the display providing a visual representation of a physical object, the display providing a mutual interaction between the 2D display area and the visual representation in the first and second dimensions.

2. The display of claim 1, further comprising a third dimension enabling a 3D display area, each dimension interfacing with a corresponding portion of the 3D display area.

3. The display of claim 2, wherein each of the first, second and third dimensions correspond to an x axis, y axis, and z axis.

4. The display of claim 2, wherein a mutual feedback path enables the virtual object shown and the 3D display area to be linked.

5. The display of claim 1, wherein at least one dimension is associated with a programmable fader or a fine motor control.

6. A method of displaying a virtual object in 2D, namely in a first and second dimension, the method comprising the steps of:
generating with a processor a 2D display area, bounded by the first and second dimensions;
displaying with a display device, at least a portion of an object visually within the 2D display area; and
selectively controlling via a data axis the portion of the object displayed by defining, in each dimension, a display range, the display range corresponding to the portion of the object being displayed in the 2D display area.

7. The method as claimed in claim 6, further comprising generating with the processor a third dimension, and a 3D display area, bounded by the first, second and third dimensions;
displaying with the display device at least a portion of an object visually within the 3D display area; and
selectively controlling via the data axis the portion of the object displayed by defining, in each dimension, a display range, the display range corresponding to the portion of the object being displayed in the 3D display area.

8. The method as claimed in claim 6, wherein a user selectively controls the portion of the object displayed by defining the display range in each dimension and/or the orientation of the object in the display area.

9. The method as claimed in claim 6, wherein the portion of the object displayed is selectively controlled via a slider and/or rotatable knob.

10. The method as claimed in claim 7, wherein each of the first, second and third dimensions correspond to an x axis, y axis, and z axis.

11. The method as claimed in claim 6, further comprising providing a pointer in the virtual environment that operates with a physical control associated with at least one dimension.

12. The method as claimed in claim 6, wherein the 2D display area is Euclidean.

13. The method as claimed in claim 6, wherein a selective control for selectively controlling the object displayed is orientation-congruent.

14. A method of displaying a virtual object in 2D, namely in a first dimension and a second dimension, the method comprising:
a physical 2D display area, bounded by the first dimension and second dimension, displaying, with a display device, at least a portion of an object visually within the physical 2D display area;
wherein, in a first mode, the portion of the object displayed by the display device is selectively controlled by defining, in each dimension, a display range, the display range corresponding to the portion of the object being displayed in the 2D display area wherein the selective control is provided by a user defining the display range in each dimension and/or the orientation of the object in the display area; and
wherein, in a second mode, the portion of the object displayed by the display device is selectively controlled by defining, in each dimension, a display range, the display range corresponding to the portion of the object being displayed in the 2D display area wherein the selective control is provided by a user interacting with the virtual display to control the physical 2D display area bounded by the first, second and third dimensions.

15. The method as claimed in claim 14, further comprising providing a third dimension, and a physical 3D display area, bounded by the first, second and third dimensions, displaying via the display device at least a portion of an object visually within the 3D display area;
wherein in a first mode, the portion of the object displayed by the display device is selectively controlled by defining, in each dimension, a display range, the display range corresponding to the portion of the object being displayed in the 3D display area wherein the selective control is provided by a user defining the display range in each dimension and the orientation of the object in the display area; and
wherein in a second mode, the portion of the object displayed by the display device is selectively controlled by defining, in each dimension, a display range, the display range corresponding to the portion of the object being displayed in the 3D display area wherein the selective control is provided by a user interacting with the virtual display to control the physical 3D display area bounded by the first, second and third dimensions.

16. The method as claimed in claim 14, wherein the selective control is provided by defining the display range in each dimension and the orientation of the object in the display area.

17. The method as claimed in claim 14, further comprising actuating a slider and/or rotatable knob to selectively control the object displayed by the display device.

18. A method as claimed in claim 15, wherein each of the first, second and third dimensions correspond to an x axis, y axis, and z axis.

19. The method as claimed in claim 14, further comprising providing a pointer in the virtual environment that mutually operates with a physical control associated with at least one dimension.

20. The method as claimed in claim 14, wherein a selective control for selectively controlling the portion of the object displayed by the display device is orientation-congruent.
